(19) United States
(12) Patent Application Publication
(10) Pub. No.: US 2018/0284954 A1
(43) Pub. Date: Oct. 4, 2018

(54) IDENTIFYING A TARGET AREA TO DISPLAY A POPUP GRAPHICAL ELEMENT

(71) Applicant: Lenovo Enterprise Solutions (Singapore) Pte. Ltd., Singapore (SG)

(72) Inventors: Matthew R. Alcorn, Durham, NC (US); James G. McLean, Raleigh, NC (US)

(21) Appl. No.: 15/474,398

(22) Filed: Mar. 30, 2017

(51) Int. Cl. G06F 3/0482; G06F 3/0484; G06F 3/0485

(52) U.S. Cl. CPC G06F 3/0482; G06F 3/0485; G06F 3/04847

(57) ABSTRACT

An apparatus includes at least one storage device for storing program instructions and at least one processor for processing the program instructions to: display first content in a graphical user interface, wherein the first content is selected from the group consisting of images, text and combinations thereof; identify a target area of the graphical user interface where the first content has a predetermined characteristic; and display a popup graphical element in the identified target area of the graphical user interface on top of the first content. Another embodiment may include at least one processor for processing the program instructions to track a user's eyes to identify a target area of the graphical user interface that is not actively being viewed by the user, and display a popup graphical element in the identified target area of the graphical user interface on top of the first content.

### BACKGROUND

The present disclosure relates to the use of popup elements in a graphical user interface.

### BACKGROUND OF THE RELATED ART

A graphical user interface (GUI) is a type of user interface that allows a user to interact with a computing device by manipulating various graphical or visual elements instead of relying on a command-line interface. The consistent use of visual elements in a graphical user interface can simplify a user's interaction with software applications. Non-limiting examples of visual elements in a graphical user interface include windows, menus, icons, controls and tabs. Interaction with these visual elements or the content within these visual elements may involve manipulation of a cursor, pointer, or insertion point using a pointing device. Non-limiting examples of a pointing device include a mouse, trackpad, trackball, or touch screen.

A popup is a visual element of a graphical user interface that appears as a result of some interaction with a visual element or content within a visual element, or perhaps by some program code associated with the content of a visual element. For example, a point and click gesture with a pointing device may generate a context menu. As another example, a file that is downloaded and executed in a window may generate a popup element, such as a popup advertisement (popup ad).

Unfortunately, any particular program may generate a popup in a location of the graphical user interface that may obscure or cover content that is being displayed by the same or different program. For example, a popup may cause a problem where the popup obscures content that is currently being used, content that is required in order for a user to fully understand the context of the popup, and/or content required to properly act on the popup.

### BRIEF SUMMARY

One embodiment provides an apparatus comprising at least one storage device for storing program instructions and at least one processor for processing the program instructions to: display first content in a graphical user interface, wherein the first content is selected from the group consisting of images, text and combinations thereof; identify a target area of the graphical user interface where the first content has a predetermined characteristic; and display a popup graphical element in the identified target area of the graphical user interface on top of the first content.

Another embodiment provides a computer program product comprising computer readable storage media that is not a transitory signal having program instructions embodied therewith, the program instructions executable by a processor to: display first content in a graphical user interface, wherein the first content is selected from the group consisting of images, text and combinations thereof; identify a target area of the graphical user interface where the first content has a predetermined characteristic; and display a popup graphical element in the identified target area of the graphical user interface on top of the first content.

A further embodiment provides an apparatus comprising at least one storage device for storing program instructions and at least one processor for processing the program instructions to: display first content in a graphical user interface, wherein the first content is selected from the group consisting of images, text and combinations thereof; track a user's eyes to identify a target area of the graphical user interface that is not actively being viewed by the user; and display a popup graphical element in the identified target area of the graphical user interface on top of the first content.

### BRIEF DESCRIPTION OF THE SEVERAL VIEWS OF THE DRAWINGS

FIG. 1A is an illustration of a laptop computer.

FIG. 1B is a diagram of a display screen.

FIG. 1C is a diagram illustrating an example of how run-length encoding may be used to identify a target area for a popup.

FIG. 1D is a diagram of a display screen displaying various content and a graphical element relating a popup to a portion of text.

FIG. 2 is a diagram of a computer.

FIG. 3 is a flowchart of actions taken by a processor according to one embodiment.

FIG. 4A is an illustration of a laptop computer with a camera for eye tracking.

FIG. 4B is a diagram of a display screen.

FIG. 5 is a flowchart of actions taken by a processor according to another embodiment.

### DETAILED DESCRIPTION

One embodiment provides an apparatus comprising at least one storage device for storing program instructions and at least one processor for processing the program instructions to: display first content in a graphical user interface, wherein the first content is selected from the group consisting of images, text and combinations thereof; identify a target area of the graphical user interface where the first content has a predetermined characteristic; and display a popup graphical element in the identified target area of the graphical user interface on top of the first content.

The at least one storage device and the at least one processor may be components of a computing device. For example, the computing device may be selected from the group consisting of a desktop computer, laptop computer, tablet computer, and smartphone. In one option, the computing device may further include an integral display device, such as a touchscreen of a tablet computer or smartphone. In another option, the computing device may be connected to an external display device, such as a desktop computer having cable or wireless connection to a display screen. Embodiments of the computing device may further include or connect with a camera facing a user that is viewing the display device in order to facilitate eye tracking.

The popup graphical element may, for example, be selected from the group consisting of a message, context menu, icon, form, action box and combinations thereof. In one embodiment, the first content is displayed in a first window of the graphical user interface, wherein the popup graphical element is a second window of the graphical user interface. For example, embodiments may provide a significant benefit where the popup graphical element is a form, since a user may need the first content, or at least find the first content helpful, for filling out the form. As another example, embodiments may be beneficial where the popup graphical element is an action box, since the first content may help the user determine how to respond to the action box.

These and other embodiments address the technological problem of displaying a popup graphical element over first content, and provide the technological solution of identifying a target area of a graphical user interface where the first content already being displayed has a predetermined characteristic and displaying the popup graphical element in the identified target area of the graphical user interface on top of the first content. Accordingly, the operation of the computing device is improved by coordinating the display of the popup graphical element and the first content in a manner that avoids obscuring the most useful portion of the first content from the view of the user.

Furthermore, the popup graphical element may be displayed in the identified target area of the graphical user interface on top of the first content either by displaying a new popup graphical element in the identified target area or by moving an existing popup graphical element to the identified target area from another position within the graphical user interface. Over time, the target area may be periodically or continuously identified and may be in a different position within the graphical user interface, for example due to changes in the first content, changes in the popup graphical element, or the existence of multiple popup graphical elements.

Without limitation, the popup graphical element may be generated by a local program selected from the group consisting of an application program, web browser and an operating system. While a remote web server may produce content for a popup, a local web browser may be responsible for generating and positioning the actual popup graphical element within the graphical user interface. In further embodiments, the graphical user interface may be selected from the group consisting of a two-dimensional interface, a three-dimensional interface, a virtual reality interface, and an augmented reality interface. In one specific embodiment, an application program may generate the popup graphical element and request that an operating system identify the position for displaying the popup graphical element. In another specific embodiment, the graphical user interface may provide a three dimensional environment including a plurality of display elements, wherein the identified position is one of the plurality of display elements. For example, a popup menu may be displayed on a display element, such as a building, wall or table top, within the three dimensional environment.

In one embodiment, the at least one processor may further process the program instructions to identify an amount of area required for displaying the popup graphical element. Accordingly, multiple potential target areas may be determined to be available for displaying the popup graphical element depending upon the amount of area required.

In various embodiments, the predetermined characteristic may be, for example, an amount of text over an area greater than or equal to the required amount of area. Alternatively, the predetermined characteristic may be selected from the group consisting of fewer than a predetermined number of text characters per unit of area or fewer than a predetermined number of colors. Other predetermined characteristics may be developed in order to identify target areas that are not likely to convey much information to the user.

In a further embodiment, the at least one processor may further process the program instructions to identify a target area of the graphical user interface where the first content has a predetermined characteristic by identifying text in one or more areas of the displayed first content and determining that the identified text does not have a level of importance that exceeds a predetermined level of importance. Determining a level of importance for the text may include the use of text recognition and a list of words or other text that may indicate a high level of importance. Such a list might include the words “warning”, “caution”, “important”, “error”, “attention”, etc. In another embodiment, the at least one processor may further process the program instructions to identify a target area of the graphical user interface where the first content has a predetermined characteristic by identifying an area within the first content that has not changed over at least a predetermined period of time. Determining that content hasn't changed over a period of time may indicate that the content is an static border area or other content that the user either doesn't need or has had ample opportunity to view. In yet another embodiment, the at least one processor may further process the program instructions to identify a target area of the graphical user interface where the first content has a predetermined characteristic by identifying a sequence of consecutive scan lines, wherein each scan line has a single data value with a pixel count that matches or exceeds the width of the popup graphical element, and wherein the sequence of consecutive scan lines have the same data value in the same position along the scan lines, wherein the number of consecutive scan lines in the sequence matches or exceeds the height of the popup graphical element. Alternatively, the pixels may have a predetermined characteristic of a regular repeating pattern of data values indicating that the area is merely displaying a background or “wallpaper”.

In further embodiments, the at least one processor may further process the program instructions to modify a parameter of the popup graphical element to reduce an amount of the first content that is hidden by the popup graphical element in response to detecting a change in a window displaying the first content, wherein the change is selected from the group consisting of resizing, repositioning, scrolling and combinations thereof. Accordingly, when the window displaying the first content is changed, the popup graphical element may be automatically modified to reduce an amount of the first content that is hidden by the popup graphical element. Optionally, the parameter of the popup graphical element that is modified may be selected from the group consisting of position, size, shape (length, width) and combinations thereof.

Optionally, the at least one processor may further process the program instructions to display a further graphical element extending between the popup graphical element and a portion of the first content that is contextually related to the popup graphical element. Non-limiting examples of the further graphical element may be selected from a line, arrow, colored outlining and combinations thereof. In this manner, if a popup (such as a context menu) is generated (such as with a right click) near a given image or text but is displayed in a target area distant from the given image or text, the further graphical elements can clearly illustrate that the popup is related to the given image or text.

In a further option, the at least one processor may further process the program instructions to monitor user repositioning of a popup window, identify a position of the graphical user interface to which the popup graphical element has been repositioned by the user, and automatically position a subsequent instance of the popup window in the identified position of the graphical user interface. For example, the processor may keep a record of drag and drop actions involving a popup window, especially including the identified position to which the popup window is repositioned. A subsequent instance of the popup window, such as a context menu, may be automatically displayed in the identified position. In a related option, the at least one processor may further process the program instructions to track user repositioning of a plurality of popup windows, identify target content that has been hidden by user repositioning of at least one of the plurality of popup windows, and identify the target area by determining the position of a portion of the first content that matches the identified target content. In this latter option, a record is made of the content that is hidden due to the user repositioning of the popup window, and this target content is identified as having a reduced importance. Accordingly, a position of the graphical user interface that is displaying the target content may identify a target area where a subsequent popup menu may be automatically positioned.

Another embodiment provides a computer program product comprising computer readable storage media that is not a transitory signal having program instructions embodied therewith, the program instructions executable by a processor to: display first content in a graphical user interface, wherein the first content is selected from the group consisting of images, text and combinations thereof; identify a target area of the graphical user interface where the first content has a predetermined characteristic; and display a popup graphical element in the identified target area of the graphical user interface on top of the first content. The foregoing computer program product may further include program instructions for implementing or initiating any one or more aspects of the embodiments described herein. Accordingly, a separate description of the embodiments will not be duplicated in the context of a computer program product.

A further embodiment provides an apparatus, such as a computing device, comprising at least one storage device for storing program instructions and at least one processor for processing the program instructions to: display first content in a graphical user interface, wherein the first content is selected from the group consisting of images, text and combinations thereof; track a user's eyes to identify a target area of the graphical user interface that is not actively being viewed by the user; and display a popup graphical element in the identified target area of the graphical user interface on top of the first content. In one option, the at least one processor may further process the program instructions to: track a user's eyes to further identify the target area as an area of the graphical user interface that is viewed less frequently than a predetermined viewing frequency; and confirm that the identified target area is within the area of the graphical user interface that is viewed less frequently than the predetermined viewing frequency prior to displaying the popup window in the target area.

Embodiments of the computing device may further include or connect with a camera facing a user that is viewing the display device in order to facilitate eye tracking. Depending upon the camera resolution, the software application capabilities, and the proximity of the person, the accuracy of the central focus area may be determined with greater or lesser accuracy. Optionally, the size or shape of the central focus area may be manually fixed or dynamically variable to identify a central focus area. Areas of the graphical user interface that are outside the central focus area may be identified as a target area for display of a popup graphical element.

It should be appreciated that the area of the display screen that is determined to be the central focus area may change dynamically in response to any detected change in the direction of focus of the at least one eye of the person. For example, as an image or sequence of images are displayed on the display screen, the camera continues to monitor the direction of focus of at least one eye of a person and determine an area of the display screen that is currently a central focus area. It is expected that the central focus area may change dynamically as the person scans their focus across the image or as one or more elements in the image move within the area of the display screen.

Ray-tracing may be used to determine key items that a user needs to maintain visibility for. Ray-tracing allows eye-tracking to be extended and applied to VR/AR environments. For example, as a user moves around within a 3D space, the user's gaze may be tracked as rays that can be analyzed in three dimensions to determine which objects or areas in the space are currently, recently or frequently being observed, and then position or reposition the popup image to avoid covering or interfering with an important item.

Embodiments described herein in the context of a two-dimensional (2D) display screen, may also be applied to a three-dimensional (3D) environment, including virtual reality (VR) and augmented reality (AR). For example, in a 3D environment it is still possible to analyze text, information density, and/or previous user behavior to identify a position for a popup graphical element. Even in the absence of text, an area determined to contain more information may be avoided when presenting a new popup graphical element in the 3D environment. Similarly, a user history of moving or relocating a popup element to a particular side, wall, area or position may be used as a basis for similarly moving or relocating a further popup element.

The foregoing apparatus may further process the program instructions to implement or initiate any one or more aspects of the embodiments described herein.

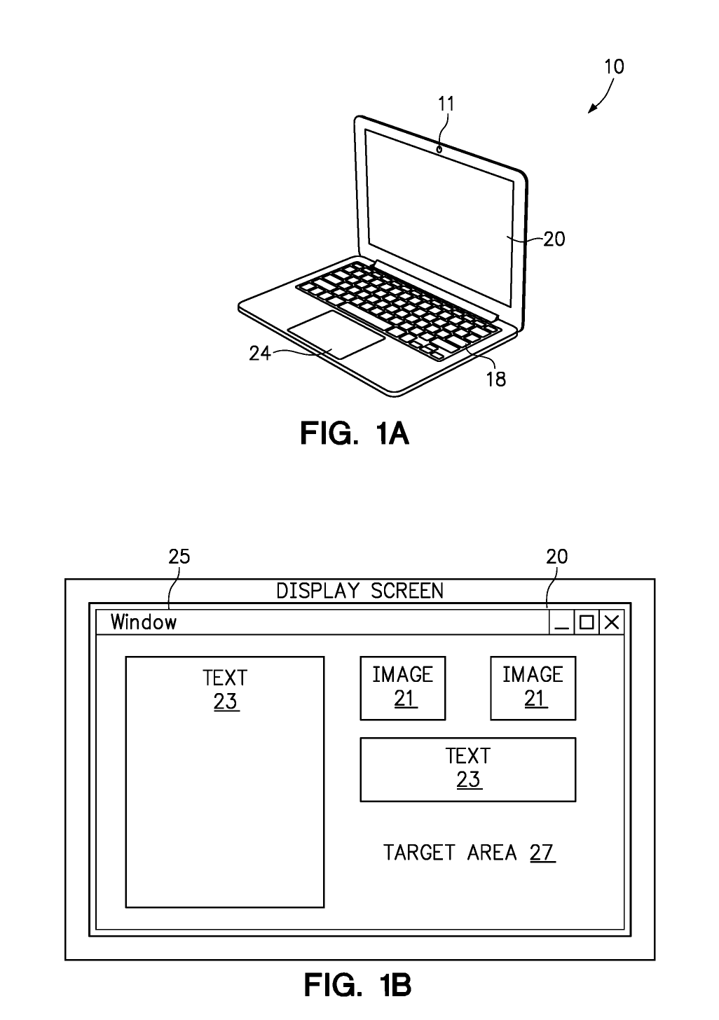

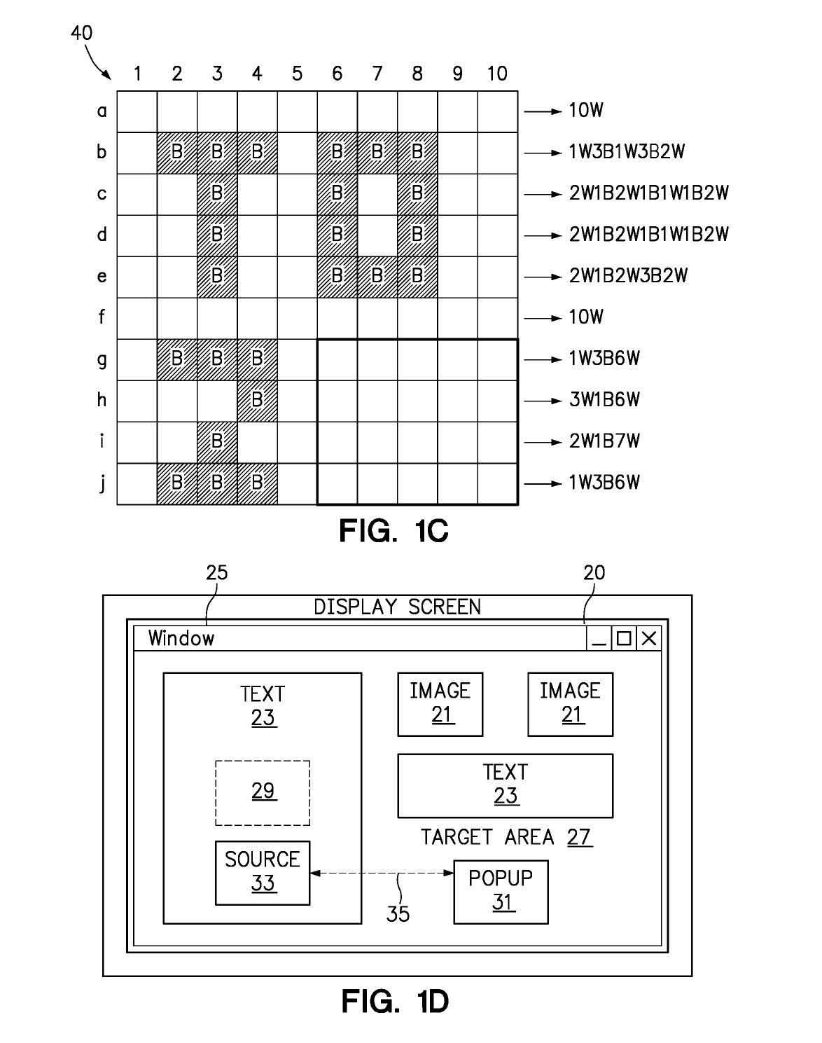

FIG. 1A is an illustration of a laptop computer 10. The laptop computer 10 is just one example of a computing device in which various embodiments may be implemented. While the laptop computer 10 will include at least one storage device (not shown; see FIG. 2) for storing program instructions and at least one processor (not shown; see FIG. 2) for processing the program instructions, the laptop computer 10 is shown including a display screen 20, keyboard 18, trackpad 24, and camera 11.

FIG. 1B is a diagram of a display screen 20. The display screen 20 is used to display first content in a graphical user interface (GUI) including a window 25, wherein the first content include images 21 and areas of text 23. As shown, a target area 27 of the graphical user interface has been identified where the first content (images 21 and text 23) has the predetermined characteristic of having no (or low) content. Accordingly, it is possible to display a popup graphical element in the identified target area 27 of the graphical user interface on top of the first content in the window 25 without obscuring or hiding content that the user may be viewing.

FIG. 1C is a diagram illustrating a non-limiting example of how run-length encoding may be used to identify a target area for a popup graphical element. Run-length encoding is a type of lossless data compression in which a sequence of the same data value is represented as a single data value and a count of how many times the data value is consecutively repeated. In this example, run-length encoding is used to described an image being displayed on a display screen. Specifically, a grid is shown where each square represents an individual pixel of a display screen. It should be understood that any individual display screen may provide greater pixel density or other variations.

A target area (i.e., an area with no or minimal characters or images) in a graphical user interface that uses run-length encoding may be identified in a two-step process. First, identify a scan line (i.e., a horizontal row) having a single data value with a sufficiently high count to at least match the width of a desired popup. Second, identify an uninterrupted sequence of consecutive scan lines (i.e., vertically adjacent) having the same data value (i.e., color) in the same horizontal position along the scan line, wherein the sequence of consecutive scan lines includes a sufficient number of lines to at least match the height of the desired popup.

In FIG. 1B, a simplified portion of a display screen is illustrated as having a 10 x 10 pixel array, including 10 scan lines (labeled a through j) and each scan line having 10 pixels (labeled 1 through 10). Of course, current pixel densities are much higher than in this example and are not limited. For example, a 1080p display screen has 1080 horizontal scan lines and 1920 pixels in each scan line. Display screens may have different aspect ratios (i.e., ratio of horizontal and vertical dimensions) and pixel densities.

As shown, the pixel array 40 is a 10×10 array that is presently displaying “TO” and “2”. Once example format of a run length encoding scheme is shown to the right of each corresponding scan line (labeled a through j). For example, scan line “a” has all white and is encoded “10W” since there are 10 white pixels. Scan line “b” include portions of the text “TO” and is encoded as “1W3B1W3B2W” since the sequence includes, in order from left to right, one white pixel, three black pixels, one white pixel, three black pixels, and two white pixels. Other colors may include utilized, but are not shown in this simplified example.

If a hypothetical popup needed a 4×4 pixel area for display, the procedure may look for a scan line with a number of at least 4. In the example, the first scan line to include a number of at least 4 is scan line “a”. However, scan line “b” does not include a number of at least 4. Scan line f includes the number 10, and the next four scan lines also include a number of at least 4. Further analysis shows that scan lines f through j include a white area that is six pixels wide and five pixels high. In this example, if logic requires a one pixel border to separate the popup from other text, then the result is a target area that is 5 (wide)×4 (high). The hypothetical popup may be displayed within the target area without obscuring or hiding any of the previously displayed content. This methodology may be expanded to any pixel density and any text density requirement. For example, if no target area can be identified with no text, then an area of minimal text or other color changes may be identified.

The method may be repeated in order to reposition a popup window in the identified target area of the display screen in response to various changes in the displayed image. Optionally, the method may further include resizing or reshaping the popup window. While the positioning, repositioning, resizing or reshaping of the popup may be performed in order to initially render a given popup in a target area of a displayed image, the method may also be used to in response to changes in the content of the displayed image, such as when a window is minimized, maximized, resized, repositioned or scrolled.

FIG. 1D is a diagram of a display screen 20 displaying various content in a graphical user interface (GUI) including a window 25, wherein the first content includes images 21 and areas of text 23. Rather than position a popup graphical element 29 (shown in dashed lines) in a position that hides some of the text 23, a popup graphical element 31 has been positioned in the target area 27. It should be recognized that the target area 27 is not a designated area for a popup, but is an area of no (or low) content in the window 25 that has been identified at the time that an application program needs to display a popup graphical element. Accordingly, the popup graphical element 31 is displayed in the identified target area 27 of the graphical user interface on top of the first content in the window 25 without obscuring or hiding any (or a minimal amount of) content that the user may be viewing.

As shown, the content includes text 23 that has a source 33, which may be a link, hot button or the location at which a context menu is triggered (such as with a right click). However, when the popup graphical element 31 is generated, it is displayed in the target area 27, which was identified because of the low content in that area rather than being positioned close to the source 33. In this instance, the target area 27 is not immediately adjacent the source 33, such that a user may not easily understand that the popup graphical element 31 is related to the source 33. Accordingly, a linking graphical element 35 (i.e., dashed line) is provided to visually indicate to the user that the popup 31 is related to the source 33. Even if the popup 31 is repositioned in response to a change in the displayed content, the linking graphical element 35 may also be repositioned in order to visually indicate that the popup 31 is still related to the source 33.

FIG. 2 is a diagram of a computer 100 that is representative of the computer 10 of FIG. 1 according to one embodiment. The computer 100 includes a processor unit 104 that is coupled to a system bus 106. The processor unit 104 may utilize one or more processors, each of which has one or more processor cores. A graphics adapter 108, which drives/supports a display 20, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, including a camera 11, a keyboard 18, and a USB mouse 24 (or other type of pointing device) via USB port(s) 126. As depicted, the computer 100 is able to communicate with other network devices over the network 40 using a network adapter or network interface controller 130.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as a lowest level of volatile memory in the computer 100. This volatile memory includes additional higher levels of volatile memory (not shown), including, but not limited to, cache memory, registers and buffers. Data that populates the system memory 136 includes the operating system (OS) 138 and application programs 144.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 may be a text-based, line-oriented user interface, the present invention may support other user interface modes, such as graphical, voice, gestural, etc.

As depicted, the operating system 138 also includes the kernel 142, which includes lower levels of functionality for the operating system 138, including providing essential services required by other parts of the operating system 138 and application programs 144. Such essential services may include memory management, process and task management, disk management, and mouse and keyboard management.

As shown, the computer 100 includes application programs 144 in the system memory of the computer 100, including, without limitation, a content analysis module 145, a central focus area (eye focus) determination module 146 and a popup position management module 148 in order to implement one or more of the embodiments disclosed herein. Optionally, one or more of these modules 145, 146, 148 may be included in the operating system 138.

The hardware elements depicted in the computer 100 are not intended to be exhaustive, but rather are representative. For instance, the computer 100 may include alternate memory storage devices such as magnetic cassettes, digital versatile disks (DVDs), Bernoulli cartridges, and the like. These and other variations are intended to be within the scope of the present invention.

A program that wishes to provide smart popup positioning could use an application programming interface (API) to access a camera driver and then do the processing itself. If the function for smart popup positioning is built into the Operating System (OS), an application program, such as a browser, may access this smart popup function through an API or OS call in order to identify a target area of the display screen where the application program should locate the popup window.

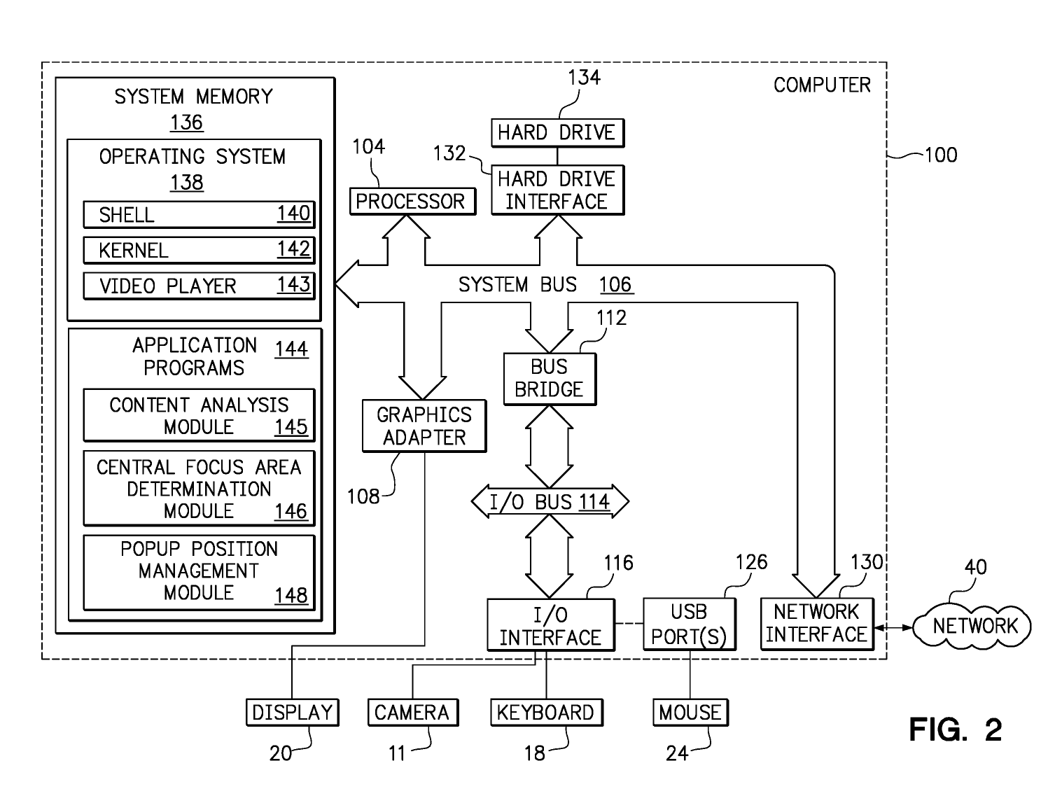

FIG. 3 is a flowchart of actions taken by a processor according to one embodiment 50. In an apparatus that comprises at least one storage device for storing program instructions and at least one processor for processing the program instructions, the at least one processor may process the program instructions to display first content in a graphical user interface, wherein the first content is selected from the group consisting of images, text and combinations thereof (step 52); identify a target area of the graphical user interface where the first content has a predetermined characteristic (step 54); and display a popup graphical element in the identified target area of the graphical user interface on top of the first content (step 56).

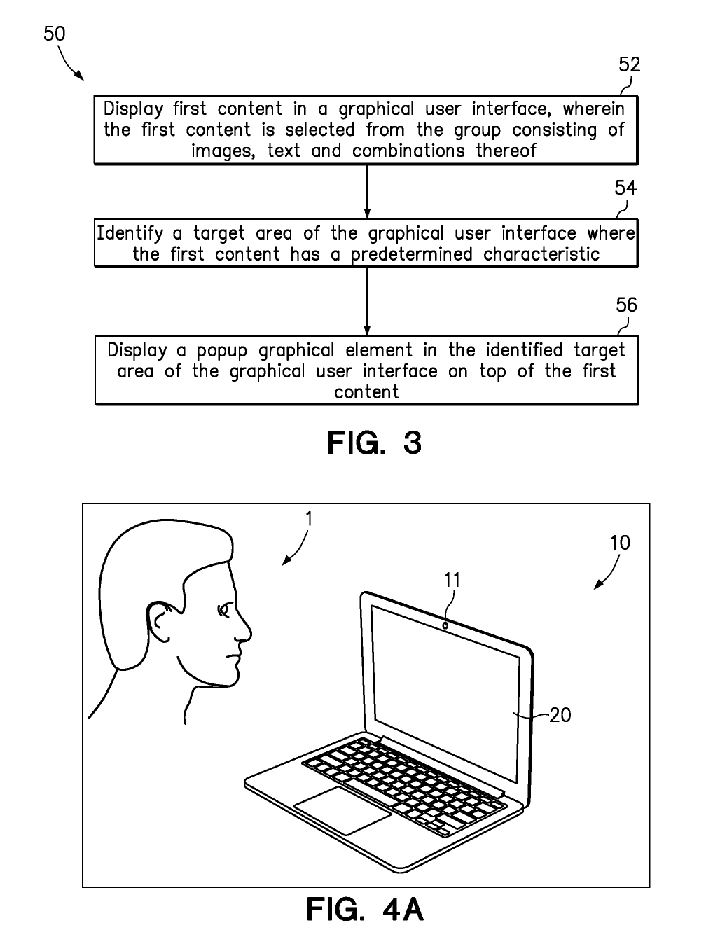

FIG. 4A is an illustration of a laptop computer 10 with a camera 22 for eye tracking. The camera 11 is directed at a user 1 that is facing the display screen 20. Using an eye tracking application, a central focus area determination module (see module 146 in FIG. 2) may determine a central focus area of the display screen 20 where the user's eyes are currently focused. By determining where the user's eyes are currently focused and/or wherein the user's eyes have recently been focused, the central focus area determination module can determine what displayed content should not be hidden by a popup graphical element.

FIG. 4B is a diagram of the display screen 20 illustrating the central focus area 60 that has been determined to be the area of the display screen where the user's eyes are focusing. Accordingly, the target area 62 may be any area of the display screen outside of the central focus area 60. Optionally, the central focus area determination module may determine a recent focus area 61 where the user's eyes have been focused over some previous period of time. In this option, the target area 62 may be any area of the display screen outside of the recent focus area 61. Still further, multiple criteria may be implemented in determining the target area 62. For example, the target area 62 may be an area outside the recent focus area 61 wherein there also no (or low) content. In this illustration, the popup graphical element 31 is positioned within the target area 62, which is outside the recent focus area 61 and between the image 21 and the text 23.

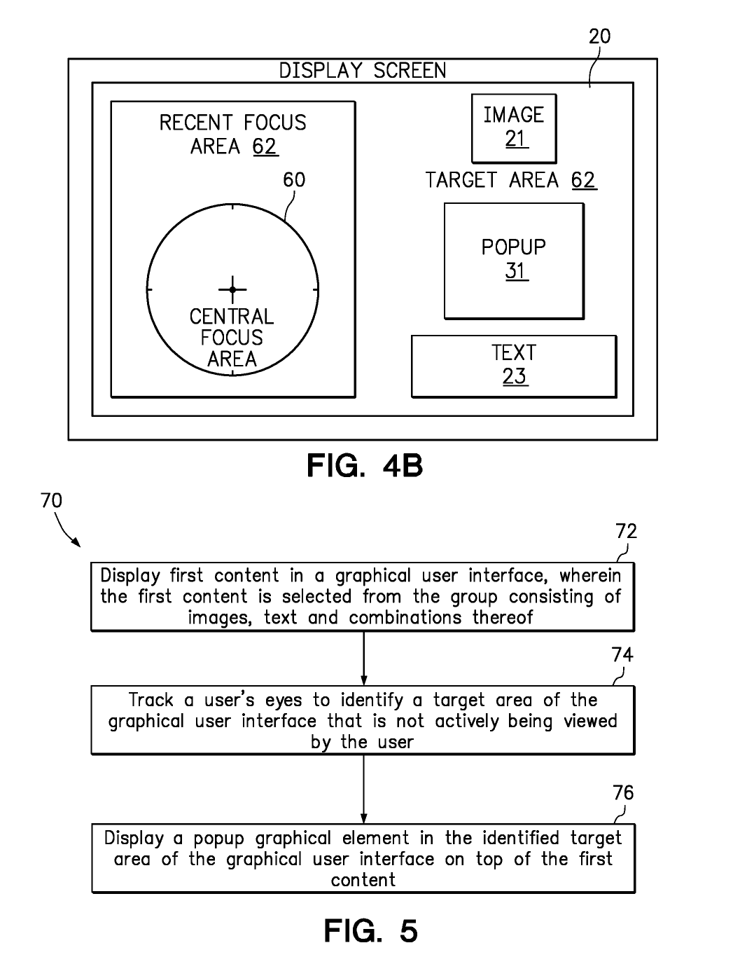

FIG. 5 is a flowchart of actions taken by a processor according to another embodiment 70. In an apparatus that comprises at least one storage device for storing program instructions and at least one processor for processing the program instructions, the at least one process may process the program instructions to: display first content in a graphical user interface, wherein the first content is selected from the group consisting of images, text and combinations thereof (step 72); track a user's eyes to identify a target area of the graphical user interface that is not actively being viewed by the user (step 74); and display a popup graphical element in the identified target area of the graphical user interface on top of the first content (step 76).

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An apparatus, comprising:
at least one storage device for storing program instructions; and
at least one processor for processing the program instructions to:
display first content in a graphical user interface, wherein the first content is selected from the group consisting of images, text and combinations thereof;
identify a target area of the graphical user interface where the first content has a predetermined characteristic; and
display a popup graphical element in the identified target area of the graphical user interface on top of the first content.

2. The apparatus of claim 1, wherein the first content is displayed in a first window of the graphical user interface, and wherein the popup graphical element is a second window of the graphical user interface.

3. The apparatus of claim 1, wherein the popup graphical element is selected from the group consisting of a popup message and a context menu.

4. The apparatus of claim 1, wherein displaying a popup graphical element in the identified target area on top of the displayed content, includes displaying a new popup graphical element in the identified target area.

5. The apparatus of claim 1, wherein displaying a popup graphical element in the identified target area on top of the displayed content, includes moving an existing popup graphical element to the identified target from another location within the graphical user interface.

6. The apparatus of claim 1, the at least one processor for further processing the program instructions to:
identify an amount of area required for displaying the popup graphical element, wherein the predetermined characteristic is an amount of text over an area greater than or equal to the required amount of area.

7. The apparatus of claim 1, wherein the predetermined characteristic is selected from the group consisting of fewer than a predetermined number of text characters per unit of area or fewer than a predetermined number of colors.

8. The apparatus of claim 1, the at least one processor for further processing the program instructions to:
identify a target area of the graphical user interface where the first content has a predetermined characteristic by identifying text in one or more areas of the displayed first content and determining that the identified text does not have a level of importance that exceeds a predetermined level of importance.

9. The apparatus of claim 1, the at least one processor for further processing the program instructions to:
identify a target area of the graphical user interface where the first content has a predetermined characteristic by identifying an area within the first content that has not changed over at least a predetermined period of time.

10. The apparatus of claim 1, the at least one processor for further processing the program instructions to:
identify a target area of the graphical user interface where the first content has a predetermined characteristic by identifying a sequence of consecutive scan lines, wherein each scan line has a single data value with a pixel count that matches or exceeds the width of the popup graphical element, and wherein the sequence of consecutive scan lines have the same data value in the same position along the scan lines, wherein the number of consecutive scan lines in the sequence matches or exceeds the height of the popup graphical element.

11. The apparatus of claim 1, the at least one processor for further processing the program instructions to:
modify a parameter of the popup graphical element to reduce an amount of the first content that is hidden by the popup graphical element in response to detecting a change in a window displaying the first content, wherein the change is selected from the group consisting of resizing, repositioning, scrolling and combinations thereof.

12. The apparatus of claim 1, the at least one processor for further processing the program instructions to:
modify a parameter of the popup graphical element in response to the first window being minimized, maximized, resized, repositioned or scrolled, wherein the parameter is selected from position, size, shape and combinations thereof.

13. The apparatus of claim 1, the at least one processor for further processing the program instructions to:
display a further graphical element extending between the popup graphical element and a portion of the first content that is contextually related to the popup graphical element.

14. The apparatus of claim 1, the at least one processor for further processing the program instructions to:
monitor user repositioning of a popup window;
identify a position of the graphical user interface to which the popup graphical element has been repositioned by the user; and
automatically position a subsequent instance of the popup window in the identified position of the graphical user interface.

15. The apparatus of claim 1, the at least one processor for further processing the program instructions to:
track user repositioning of a plurality of popup windows;
identify target content that has been hidden by user repositioning of at least one of the plurality of popup windows; and
identify the target area by determining the position of a portion of the first content that matches the identified target content.

16. The apparatus of claim 1, further comprising:
an application program generating the popup graphical element;
the application program requesting that an operating system identify the position for displaying the popup graphical element.

17. The apparatus of claim 1, wherein the graphical user interface provides a three dimensional environment including a plurality of display elements, and wherein the identified position is one of the plurality of display elements.

18. A computer program product comprising computer readable storage media that is not a transitory signal having program instructions embodied therewith, the program instructions executable by a processor to:
display first content in a graphical user interface, wherein the first content is selected from the group consisting of images, text and combinations thereof;
identify a target area of the graphical user interface where the first content has a predetermined characteristic; and
display a popup graphical element in the identified target area of the graphical user interface on top of the first content.

19. An apparatus, comprising:
at least one storage device for storing program instructions; and
at least one processor for processing the program instructions to:
display first content in a graphical user interface, wherein the first content is selected from the group consisting of images, text and combinations thereof;
track a user's eyes to identify a target area of the graphical user interface that is not actively being viewed by the user; and
display a popup graphical element in the identified target area of the graphical user interface on top of the first content.

20. The apparatus of claim 19, the at least one processor for further processing the program instructions to:
track a user's eyes to further identify the target area as an area of the graphical user interface that is viewed less frequently than a predetermined viewing frequency; and
confirming that the identified target area is within the area of the graphical user interface that is viewed less frequently than the predetermined viewing frequency prior to displaying the popup window in the target area.
